(19) United States
(12) Patent Application Publication
(10) Pub. No.: US 2015/0012393 A1
(43) Pub. Date: Jan. 8, 2015

(54) Performance Record Based Motivation of Retail Self Checkout System Gamification

(71) Applicant: International Business Machines Corporation, Armonk, NY (US)

(72) Inventor: Graham R. Bucknell, Frenchs Forest (AU)

(21) Appl. No.: 14/492,175

(22) Filed: Sep. 22, 2014

Related U.S. Application Data
(63) Continuation of application No. 13/927,195, filed on Jun. 26, 2013.

(51) Int. Cl. G07G 1/01; G07G 1/00; G06Q 30/06

(52) U.S. Cl. CPC G07G 1/01; G06Q 30/0641; G07G 1/0054
USPC 705/27.1

(57) ABSTRACT

A computing device determines a global scan rate average based on a plurality of transactions that have been received that includes at least one scanned item and the time to scan the at least one item. The computing device responds to receiving input by a customer indicating a current transaction start, by displaying the global scan rate average to the customer. The computing device receives a number of current items scanned and the time to scan the items. The computing device determines a current scan rate based on the current number of items scanned and the current period of time to scan the current number of items. The computing device displays a comparison of the current scan rate and the global scan rate average to the customer and displays a message based on whether the current scan rate exceeds the global scan rate average.

### BACKGROUND OF THE INVENTION

The present invention relates generally to the field of retail store transaction systems, and more particularly to improving self checkout efficiency by gamification of transactions.

One of the most frustrating aspects of shopping, experienced by customers, is waiting in line to checkout and pay for purchases. Retailers consider customer satisfaction and customer experience among the most important attributes to offer their customer base, and are therefore aware and concerned about situations in which customers experience a wait time beyond customer-acceptable levels. Retailers are reluctant to increase operating costs by overstaffing checkout areas, and will sometimes resort to re-assigning staff members to checkout service from other duties during periods of high checkout demand. Although somewhat effective, retailers experience a loss of efficiency for shuffling staff members among different duties.

Retailers have tried many techniques to reduce the frustration of waiting in line by distracting customers by providing television screens viewable from checkout lines, lining checkout areas with a variety of eye-catching products and utilizing staff members to “direct” checkout traffic to lines with lower numbers of waiting customers.

Customers show low tolerance for long waits in checkout lines and can be seen leaving stores without making purchases, and leaving the items planned for purchase in baskets or carts out of frustration. This results in lost sales for the retailer and negative customer satisfaction. In some cases customers consider checkout wait times and customer service as more important than purchase price in determining where to shop. Retailers face the dilemma of improving customer satisfaction and reducing checkout wait times without incurring additional operational costs.

One response was to implement self checkout systems in which the customer scans the product with a product reading device, such as a bar code scanner, bags their own purchases and submits payment for purchases all at the same self checkout station, ideally with no intervention required by retailer staff members. The design of the self checkout systems is for the customer to control their own checkout experience, or feel that they are in control of their own checkout, and a single retailer staff member can oversee multiple self checkout stations, which reduces labor costs for the retailer.

A problem that persists is that customers can typically be slower at performing the actual checkout scanning and payment transactions than the experienced staff member, slowing down the self checkout stations and resulting in long wait lines.

### SUMMARY

Embodiments of the present invention disclose a method, computer program product, and system for increasing throughput of a self checkout device. In one embodiment, a computing device determines a global scan rate average based on a plurality of transactions that have been received, wherein each of the transactions includes at least one item that is scanned and a period of time to scan the at least one item. The computing device, in response to receiving input by a customer that indicates a start of a current transaction, displays the global scan rate average to the customer. The computing device receives input from the current transaction, including a current number of items that are scanned and a current period of time to scan the current number of items. The computing device determines a current scan rate based on the current number of items scanned and the current period of time to scan the current number of items. The computing device displays a comparison of the current scan rate and the global scan rate average to the customer of the current transaction and displays a message based on whether the current scan rate exceeds the global scan rate average.

### BRIEF DESCRIPTION OF THE SEVERAL VIEWS OF THE DRAWINGS

FIG. 1 is a functional block diagram illustrating a self checkout distributed data processing environment, in accordance with an embodiment of the present invention.

FIG. 2 is a flowchart depicting operational steps of a scanning rate program on a computing device within the data processing environment of FIG. 1, in accordance with an embodiment of the present invention.

FIG. 3 illustrates an exemplary display of scan rate information on a display of a self checkout device, in accordance with an embodiment of the present invention.

FIG. 4 depicts a block diagram of components of a computing device performing operational steps of the scanning rate program, in accordance with an embodiment of the present invention.

### DETAILED DESCRIPTION

Embodiments of the present invention recognize that when designed correctly, gamification can be successfully used to attract and motivate people to change behaviors and develop or improve skills. Gamification uses game-based activities and a game-like competitive environment in a non-game context in order to engage customers and provide motivation. Gamification techniques call upon the natural tendencies people have to compete, to set and achieve goals, to obtain status, and to pursue rewards. Leveraging some of the features used in real games, gamification can turn many other types of activities into games and harness the natural tendencies people have to produce a desired behavior.

Embodiments of the present invention further realize that self checkout systems for retail stores, having one or more stations, offer customers an alternative to waiting in lines for staff-assisted checkout of purchased items. Although customers have more control of their checkout experience by using self checkout systems, customers have less experience in scanning purchased items and may operate at a slower rate than the store staff member operating a checkout line. Slow scanning rates by customers can result in long lines and long waits for self checkout stations, and retail stores look to lose revenue by a reduced rate of purchases. Customers remain unmotivated to improve scanning rates which will only reduce wait times for other customers in line, but not affect the current customer's experience.

Gaming is based on principles of achievement and improvement. Embodiments of the present invention integrate a gaming approach using one or a combination of positive and negative feedback, to customer self checkout scanning rate, referred to as “gamification” of self checkout, to create a competitive, customer motivation to continuously improve self checkout scanning rates. Implementation of such embodiments may take a variety forms, and exemplary implementation details are discussed subsequently with reference to the Figures.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

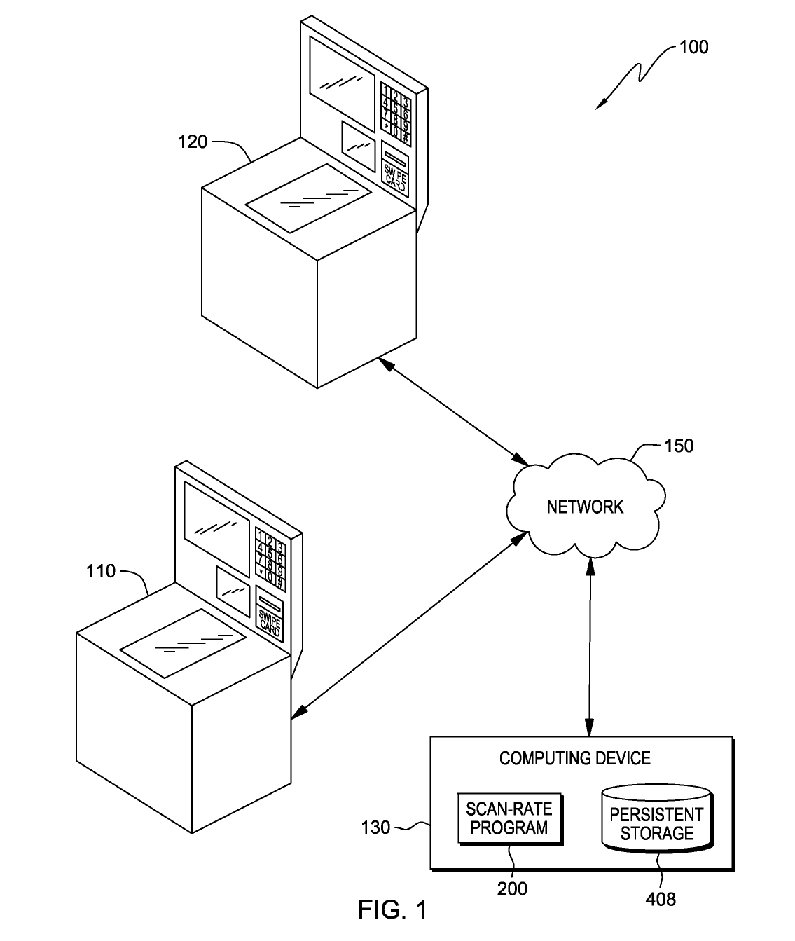

The present invention will now be described in detail with reference to the Figures. FIG. 1 is a functional block diagram illustrating a distributed data processing environment, generally designated 100, in accordance with one embodiment of the present invention. Although the following describes embodiments of the present invention as they apply to use of a self checkout device by a customer, alternative embodiments may also apply to regular staff-assisted checkout transactions performed by store staff members. Distributed data processing environment 100 includes self checkout devices 110 and 120, and computing device 130 which includes scan-rate program 200 and persistent storage 408, all interconnected through network 150.

Network 150 can be, for example, a local area network (LAN), a wide area network (WAN) such as the Internet, or a combination of the two, and can include one or a combination of: wired, wireless, or fiber optic connections. In general, network 150 can be any combination of connections and protocols that will support communication and interconnectivity between computing device 130 and self checkout devices 110 and 120.

In one embodiment of the present invention, self checkout devices 110 and 120 are two instances of self checkout stations installed in a retail store. Self checkout devices 110 and 120 are used to allow customers to checkout items they intend to purchase from the retail store. Checkout refers to the actions in which items to be purchased are identified and the price of the items to be purchased are summed, along with additional charges such as taxes and deposits, to produce an amount for which the customer must submit payment. In various embodiments of the present invention, checkout scan rates may also includes the transaction of a customer submitting payment for items to be purchased and receiving a receipt for payment made. The payment transaction may be considered as a component of the overall scan rate for a checkout transaction, or as a separately measured and displayed component for a checkout transaction.

Self checkout devices 110 and 120 are configured to scan items to be purchased by customers, identify the products, and summarize the prices and other fees, if any, of the items scanned, and display the amount of payment due to purchase the items. In one embodiment, scanning items involves using coded labels, such as bar code labels, that are included or attached to the product packaging. The bar code of the product is scanned by placing or moving the bar code over a bar code reader of the self checkout device. Other embodiments may use alternative labels or identification techniques, such as radio frequency identification (RFID) tags, to scan products to be purchased.

In one embodiment of the present invention, self checkout devices 110 and 120 are connected to a computing device, such as computing device 130, via a network connection, such as network 150. Self checkout devices 110 and 120 send scanning information to computing device 130 and receive scanning rate information to display that is produced by scan-rate program 200 residing on computing device 130. In another embodiment, self checkout devices 110 and 120 each includes a respective computing device, such as computing device 130, that receives respective scanning information and sends respective scanning rate information produced by scan-rate program 200 to be displayed on the respective self checkout device.

In one embodiment of the present invention, self checkout devices 110 and 120 represent a plurality of self checkout devices that may be located in one or more retail stores. Scanning rate information from the plurality of self checkout devices may be consolidated in a computing device, such as computing device 130, via connection to network 150.

Computing device 130 includes scan-rate program 200, which is a program that receives scanning information and sends scan rate information to display on self checkout devices 110 and 120, and persistent storage 408, which is a tangible storage device for storing scan rate information. Computing device 130 may be included within the configuration of a self checkout device, such as self checkout device 110, or alternatively computing device 130 may be connected to self checkout device 110 through network 150. Computing device 130 can be a desktop computer, laptop computer, a specialized computer server, a client computer, or any other computer system known in the art. In certain embodiments, computing device 130 may represent a computer system utilizing clustered computers and components to act as a single pool of seamless resources when accessed through a network, as is common in data centers and with cloud computing applications.

Scan-rate program 200 is accessible to computing device 130, receives input from customer scanning transactions and generates the scanning rate for the customer for the current transaction. Scan-rate program 200 also generates a global customer scan rate which is an average determined from including all scanning transaction information. In one embodiment of the present invention, this includes all transactions for given retail store. In other embodiments, the global customer scan rate average is determined from including scanning transactions from multiple stores, or, in yet another embodiment, the global customer scan rate average includes scanning transactions from a given self checkout device. Scan-rate program 200 stores information used for generating the global customer scan rate averages, a cumulative scan rate average for individual customers, a current transaction scan rate for individual customers, and in some embodiments of the present invention, the best scan rate of each individual customer.

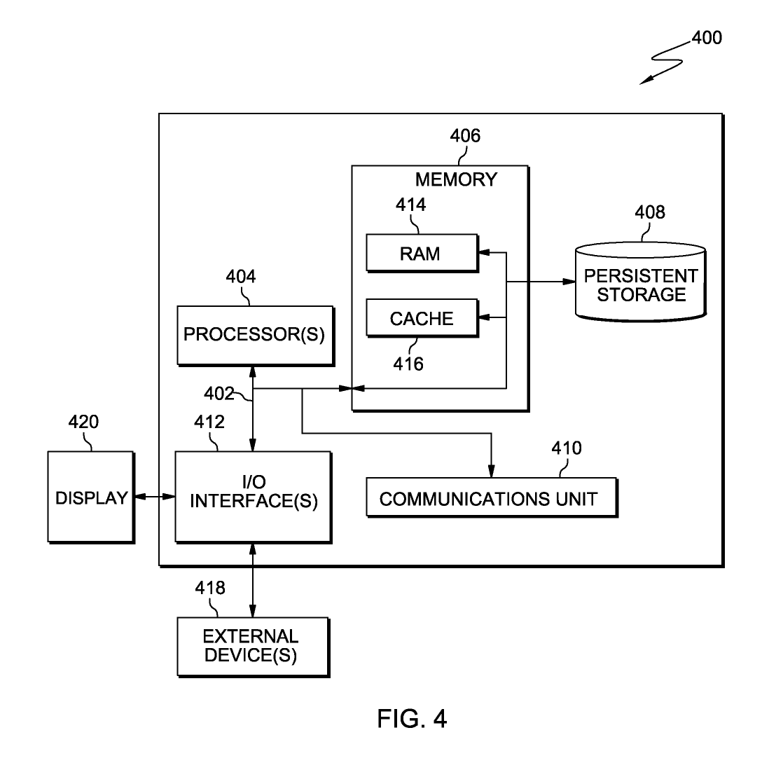

Persistent storage 408 is a tangible storage device that in one embodiment is included in computing device 130 and stores scanning rate information for a global customer scan rate average, the current scan rate of a customer scanning transaction, individual customer scan rate averages, and individual customer best scan rates. Persistent storage 408 is discussed in more detail with respect to FIG. 4.

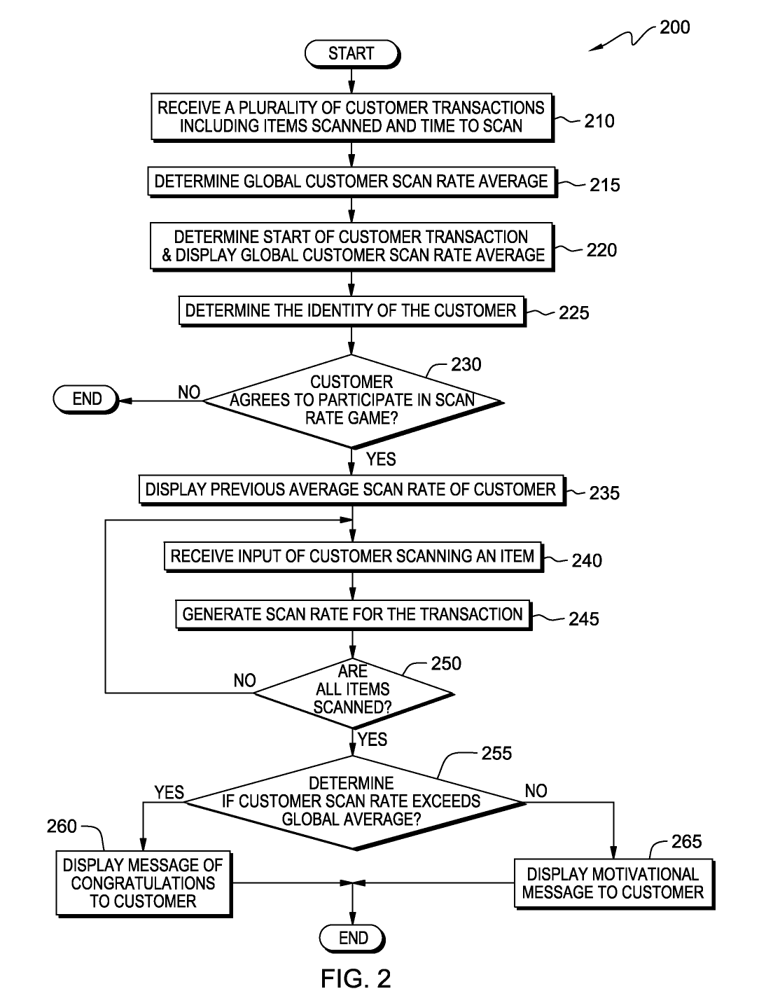

FIG. 2 is a flowchart depicting operational steps of a scanning rate program on a computing device within the data processing environment of FIG. 1, in accordance with an embodiment of the present invention. Self checkout devices, such as self checkout device 110, produce scanning information from a plurality of customer transactions. Scan-rate program 200 receives a plurality of customer transactions including the number of items scanned and the time to scan (step 210).

For example, scan-rate program 200 receives scanning information from user transactions for self checkout devices 110, 120 and a plurality of additional self checkout devices (not shown). In one embodiment, the scanning information for each transaction includes the number of items scanned and the period of time required to complete scanning of all the items scanned during the user transaction. In another embodiment, the scanning information includes the number of items scanned, the period of time required to complete scanning of all the items scanned, and the time to complete submission of payment for the items scanned.

The period of time required to complete submission of payment for the items scanned may be tracked and displayed separately from the scan rates. Scan-rate program 200 continually receives the scanning information for all subsequent self checkout device scanning transactions. In a different embodiment of the present invention, in which large numbers of self checkout devices across multiple retail stores produce scanning information, scan-rate program 200 may sample the transaction information, as required, to avoid computing device performance issues.

Having received a plurality of scanning information, scan-rate program 200 determines a global customer scan rate average (step 215). As each transaction is received from a self checkout device, such as self checkout device 110, scan-rate program 200 determines the quotient of the sum of the total number of scanned items from all received transactions, and the sum of the period of time to complete scanning of all items from all received transactions, producing a global customer scan rate average. The global customer scan rate average, also referred to as the global average, is expressed in number of items scanned, per unit of time, such as 15 scanned items per minute, for example. The global average is constantly updated by scan-rate program 200 as it receives additional transaction scanning information. A global average can be determined at any of several levels, such as for a single self checkout device, a combination of self checkout devices at a retail store, or multiple self checkout devices from multiple retail stores.

For example, scan-rate program 200 receives scanning information for 100 self checkout user transactions. Scan-rate program 200 determines a quotient of the sum the total number of scanned items for the 100 user transactions, and the sum of the period of time to complete scanning of the items from all 100 transactions. The quotient determined by scan-rate 200 is the global customer scan rate average for the 100 user transactions. Alternatively, in a different embodiment, scan-rate program 200 may determine a scan rate for each of the 100 self checkout customer transactions, and sum the scan rates for all 100 transactions and divide the sum of the scan rates by 100 (the number of transactions) to produce the global customer scan rate average.

As customer of self checkout device 110 begin a transaction, scan-rate program 200 determines the start of a customer transaction and displays the global customer scan rate average on the self checkout device display (step 220).

For example, a customer may begin a transaction on a self checkout device by using a loyalty card or a code that is unique to the customer. Alternatively, the self checkout device may offer the customer an anonymous guest identity if the customer wishes to remain anonymous and the store self checkout policy allows this. Scan-rate program 200 determines the identity of the customer (step 225), based on the customer beginning a transaction of the self checkout device by using the loyalty card or the code entry, or assigned an anonymous guest identity. Determining the identity of the customer enables associating the scanning information of the transaction to the customer and enables updating the on-going cumulative average scan rate for the customer, as well as identifying when the scan rate is better than the customer's average scan rate or if the scan rate is the best scan rate achieved by the customer. Anonymous guest identities, if used, allow only a current scan rate to be displayed as feedback to the customer.

Having determined the customer's identity or in alternate embodiments, assigning an anonymous guest identity to the customer, scan-rate program 200 presents a message to the customer on the display of the self checkout device requesting the agreement of the customer to participate in a scan rate game. If the customer responds that they do not agree to participate in the scan rate game (step 230, “No” branch), scan-rate program 200 ends. Receiving a response that the customer agrees to participate in the scan rate game, (230, “Yes” branch), scan-rate program 200 proceeds to display the previous average scan rate of the customer (step 235).

For example, scan-rate program 200 displays a message on the display of self checkout device 110 requesting the agreement of the customer to participate in a scan rate game. The customer has a choice to participate or not, and choosing to participate by a touch screen selection, for example, scan-rate program 200 retrieves the identified customer's previous scan rate average and includes the previous scan rate average along with the global average, on the display screen of self checkout device 110. Additionally, available information associated with the identified customer may be used to provide customized responses for participating in the scan rate game. In an alternative embodiment, if the customer is not identified, only the global average is displayed on the screen of the self checkout device.

In one embodiment, scan-rate program 200 presents the customer with a “start scanning” notification on the display, and receives the input of the customer scanning an item (step 240). The input includes increasing a count of the number of items scanned and a measurement of the time period from the indication of the start of scanning until the item is scanned. The start of the time period for the initial item to be scanned, in one embodiment, requires the customer to select a starting indicator on the self checkout device before beginning to scan. In other embodiments the scanning of a first item may be used to initiate time tracking and determining scanning rate on subsequently scanned items and omitting scan rate tracking for single item transactions. In yet other embodiments, the tracking of time periods may begin with the customer agreeing to participate and the self checkout device displaying the global customer scan rate average and the identified customer's scan rate average.

Retail stores will benefit from reducing the entire transaction time of customers, not only the scanning portion of the transaction. Excessive delays in submitting payment may overshadow improvements achieved in scanning rates, and overall self checkout transaction times realize no improvement. Embodiments of the present invention include tracking the time of the total transaction, which can include the time from agreement to participate, until adequate payment is submitted and acknowledged from the self checkout device.

Scan-rate program 200, having the input information from the scanned item, generates a scan rate for the transaction (step 245). Scan-rate program 200 generates the scan rate by determining the quotient of the number of items scanned, and the time period required for the items to be scanned, and presents the scan rate on the display of the self checkout device.

For example, for the first scanned item, scan-rate program 200 determines the amount of time from the start of the scan rate game, for instance, the customer selecting a start indicator on the self checkout device, until the first item is scanned and scan-rate program 200 receives the scanning information input. Scan-rate program 200 generates the scan rate, normalizing the rate to an equivalent of a number of items scanned in one minute. If the scan rate time of the first item (1 item) was 4 seconds, the scan-rate program 200 converts this to: 15×1 item per 15×4 seconds; producing a scan rate of 15 items scanned in 60 seconds, or 15 items per minute scan rate. Scan-rate 200 illustrates this scan rage on the display of the self checkout device by presenting a horizontal bar, for example, indicating the scan rate level and labeling to clarify the level of scan rate. Various techniques may be used to display scan rate feedback to the customer, and embodiments of the present invention are not limited by these techniques.

Scan-rate 200 determines if all items have been scanned for the transaction and determining that all items are not scanned (step 250, “No” branch), scan-rate program 200 loops to step 240 and receives input of the customer scanning a subsequent item. Receiving the input from the subsequently scanned item, scan-rate program 200 increases the count of the scanned items by one and records the time period between the previous item scanned and the subsequent scanned item and generates a new scan rate for the transaction (step 240).

For example, if the previous item was scanned in 4 seconds and the subsequent item was scanned in 2 seconds, scan-rate program 200 determines that there are 2 items scanned (1+1), in 6 seconds (4+2), and converts the scan information to the equivalent of the number of items scanned in a one minute period, by multiplying the items scanned by 10 (2 items×10=20), and multiplying the scanning time by 10 (6 seconds×10=60 seconds), to obtain the one minute time period. Scan-rate 200 presents the new scan rate of 20 items scanned per minute to the display of the self checkout device.

Scan-rate program 200 again determines in decision step 250, if all items are scanned, and determining that all items are scanned (step 250, “Yes” branch), scan-rate program 200 determines if the customer scan rate exceeds the global customer scan rate average. Determining that the customer scan rate for the current transaction exceeds the global average scan rate (step 255, “Yes” branch), scan-rate program 200 displays a message of congratulations to the customer (step 260).

For example, scan-rate program 200 continues to re-generate the customer's current scan rate after each item is scanned by the customer, until scan-rate program 200 receives indication from the customer that all items have been scanned. In one embodiment of the present invention, scan-rate program 200 receives input from the customer selecting a “scanning complete” or “pay now” indicator on self checkout device 110, which indicates that all items have been scanned. In another embodiment scan-rate program 200 continues to record the time after the last scanned item, until full payment has been submitted to purchase the scanned items, and includes this time in generating the final scan rate for the customer's current transaction. Having determined that the customer's scan rate for the current transaction exceeds the global customer scan rate average, scan-rate program 200 displays a complimentary message of congratulations to the customer (step 260). Having delivered a congratulatory message, scan-rate program 200 ends.

The complimentary message of congratulations acknowledges the customer having achieved a scan rate in which more items were scanned per unit of time than the number of items that were scanned on average in the same unit of time, by all recorded customer transactions. The customer's scan rate is above (better-than) average, and the displayed congratulatory message may be accompanied by other visual and audio indicators.

In one embodiment the complimentary message of congratulations is presented on the display screen of the self checkout device, such as self checkout device 110. In another embodiment, additional visual indicators associated with the self checkout device may include, but are not limited to one or a combination of: flashing of the display screen, additional lights, a message board. The self checkout device may use delivery of audio messages and indicators of achievement as acknowledgement, and include, but are not limited to one or a combination of: playing music associated with achievement, recorded or synthetic voices offering verbal forms of congratulations, and sounds that indicate successful achievement.

The use of additional visual and audio indicators of achievement may be included to support various levels of achievement beyond merely exceeding the global customer scan rate average. The additional visual and audio indicators acknowledging the achievement of the customer can be detectable by other customers. In one embodiment of the present invention, the positive results of the customer exceeding the global customer scan rate average or other targeted achievement, continues to be displayed on the self checkout scanning device for at least a subsequent customer to view. In other embodiments of the present invention, the highest customer scan rate for the current hour, day, week, month, year, greater than a year, or other time period or combination of time periods, may be displayed for motivational purposes.

If scan-rate program 200 determines that the customer scan rate for the current transaction does not exceed the global average (step 255, “No” branch), scan-rate program 200 displays a chiding message to the customer (step 265). The chiding message is a non-complimentary message that is an acknowledgement that the customer's scan rate for the current transaction was below the global customer scan rate average. The chiding message may depend upon information associated with the identity of the customer and may instead or additionally include content deemed to be effective in encouraging and motivating the customer to improve their scan rate. Having delivered a chiding (non-complementary) message to the customer, scan-rate program 200 ends.

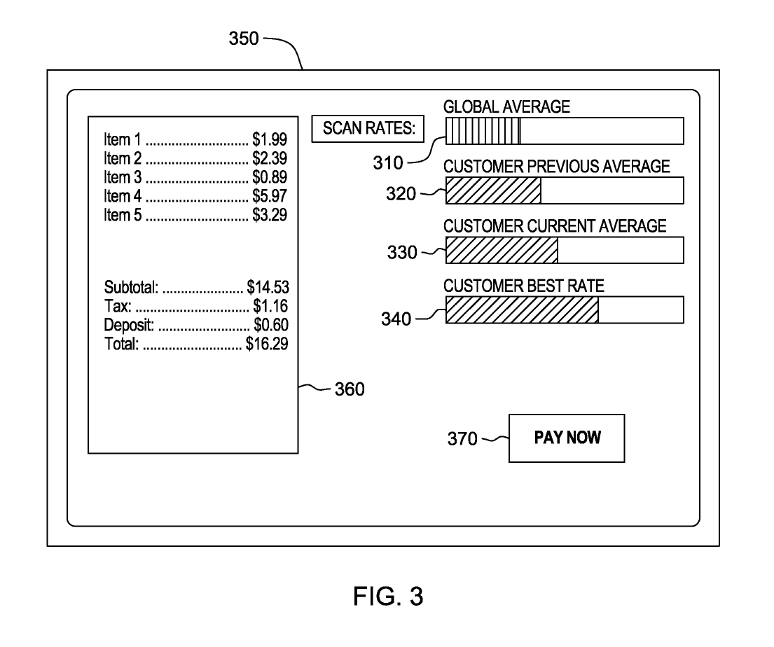

FIG. 3 illustrates an exemplary display screen including scan rate information for a self checkout device, in accordance with an embodiment of the present invention. Display screen 350 is an example of a screen output of a self checkout device operating with scan-rate program 200. In one embodiment, display screen 350 is a touch screen, which provides output to a customer and input from a customer, for a self checkout device. Display screen 350 includes global average indicator 310, previous average indicator 320, current average indicator 330, best rate indicator 340, item price listing 360 and pay now button 370.

Global average indicator 310 is an example of a horizontal bar display of a global customer scan rate average. The hashing within the horizontal bar is representative of the scan rate averaged from all customers participating in the scan rate game. Global average indicator 310 is continuously updated by scan-rate program 200 as transaction information from self checkout devices are received. The scope of global average indicator 310 can include all transactions for a given self checkout device, all the self checkout devices within a given store, or all checkout devices within multiple stores.

Previous average indicator 320 is an example of a horizontal bar display of a customer's average scan rate for all previous scanning transactions prior to the current customer scanning transaction. The hashing marks inside the horizontal bar indicate that previous average indicator 320 is at a level that exceeds global average indicator 310. Previous average indicator 320 is re-generated after a current scanning transaction is completed, adding the scanning information from the current scanning transaction to the totals of the previous scanning transactions.

Current average indicator 330 is an example of a horizontal bar display of a customer's scan rate for a current, on-going scanning transaction. Current average indicator is generated after each item is scanned, presenting a cumulative scan rate for all scanned items of the current transaction. The hash marks within the horizontal bar indicate that current average indicator 330 is at a level that exceeds the scan rate level of both global average 310 and previous average 320. If the level of scan rate for current average indicator is maintained or improved after the current scanning transaction is completed, scan-rate program 200 will produce a congratulatory message to the current scanning transaction customer.

Best rate indicator 340 is an example of a horizontal bar display of a customer's best scan rate achieved, for all previous scanning transactions. Best scan rate 340 provides a target of continuous motivation for a customer to improve performance of scanning items and other checkout transaction components as appropriate, to set best scan rate 340 to a higher achievement mark. In one embodiment of the present invention, previous average 320 and best scan rate 340 are optionally presented to the customer, providing additional gaming targets for the customer to try and exceed.

Item price listing 360 is display component of display screen 350. As each item is scanned by using a bar code or product code reader, the item identification and the price associated with the item is displayed, and a subtotal amount is updated. When all items are scanned, the appropriate amount of tax, deposits, and other fees are listed in item price listing 360. In one embodiment, when pay now button 370 is selected by a customer, item price listing 360 displays a total, indicating the amount of payment due.

Pay now button 370 is an example of a touch screen button to be activated by a customer to indicate that the customer is ready to make payment. In one embodiment of the present invention, pay now button 370 provides input to scan-rate program 200 indicating that all items are scanned.

FIG. 4 depicts a block diagram of components of a computing device, capable of operating scan-rate program 200, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Scan-rate program 200 is stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of enterprise grid 112 and client devices 104, 106, and 108. In these examples, communications unit 410 includes one or more network interface cards. Communications unit 410 may provide communications through the use of either or both physical and wireless communications links. Scan-rate program 200 may be downloaded to persistent storage 408 through communications unit 410.

I/O interface(s) 412 allows for input and output of data with other devices that may be connected to computing device 130. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., scan-rate program 200, can be stored on such portable computer-readable storage media and can be loaded onto persistent storage 408 via I/O interface(s) 412. I/O interface(s) 412 also connect to a display 420.

Display 420 provides a mechanism to display data to a customer and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for increasing throughput of a self checkout device, the method comprising:
determining a global scan rate average based on a plurality of transactions that have been received, wherein each of the transactions includes at least one item that is scanned and a period of time to the at least one item;
in response to receiving input by a customer that indicates a start of a current transaction, displaying the global scan rate average to the customer;
receiving input from the current transaction, including a current number of items that are scanned and a current period of time to scan the current number of items;
determining a current scan rate based on the current number of items scanned and the current period of time to scan the current number of items; and
displaying a comparison of the current scan rate and the global scan rate average and a message based on whether the current scan rate exceeds the global scan rate average.

2. The method of claim 1, wherein receiving input from the current transaction, further comprises:
receiving input from the current transaction that includes a first item that is scanned and a second item that is scanned, including a first period of time for the first item that is scanned and a second period of time for the second item that is scanned;
generating a current scan rate, wherein the current scan rate is based on a sum of the first item that is scanned and the second item that is scanned, and a sum of the first period of time for the first item that is scanned and the second period of time for the second item that is scanned; and
in response to scanning the second item, displaying the current scan rate.

3. The method of claim 1, wherein determining the current scan rate further comprises:
determining a payment period of time measured from when a last item is scanned until the self checkout device acknowledges payment as received; and
generating the current scan rate based on the current number of items scanned and a sum of the current period of time to scan the current number of items and the payment period of time.

4. The method of claim 3, wherein displaying a comparison of the current scan rate and the global scan rate average further comprises:
determining a global payment rate average based on a plurality of transactions that have been received, wherein each of the plurality of transactions includes at least one item for which payment is acknowledged by the self checkout device, and a payment period of time measured from when the last item is scanned until the payment is acknowledged;
in response to receiving input by the customer that indicates the start of the current transaction, displaying the global payment rate average to the customer;
receiving from the current transaction, a payment period of time from when the last item is scanned until the self checkout device acknowledges the payment;
determining a current payment rate based on the payment period of time and an acknowledgement of the payment from the self checkout device;
displaying a comparison of the current payment rate and the global payment rate average to the customer of the current transaction; and
displaying a message based on whether the current payment rate exceeds the global payment rate average to the customer of the current transaction.

5. The method of claim 1, wherein displaying a message to the customer, based on whether the current scan rate exceeds the global scan rate average, further comprises:
in response to the current scan rate exceeding the global scan rate average, displaying a complimentary message to the customer; and
in response to the global scan rate average exceeding the current scan rate, displaying a non-complementary message to the customer.

6. The method of claim 1, further comprising:
determining an identity of the customer;
receiving customer input indicating an agreement to participate in gamification of a scanning rate;
displaying a cumulative average scan rate from previous transactions of the customer; and
displaying a message to the customer, wherein the message is customized based on the identity of the customer.

7. The method of claim 6, wherein receiving the input from the customer, indicating an agreement by the customer to participate in the gamification of the scanning rate, initiates measurement of an initial period of time for a first item to be scanned.

8. The method of claim 1, further comprising:
recording each current scan rate generated on a self checkout device;
determining a highest scan rate recorded for the self checkout device; and
displaying the highest scan rate for the self checkout device for at least one of: a previous hour, a previous day, a previous week, a previous month, a previous year, greater than a year.

9. The method of claim 1, wherein displaying the message to the customer includes an audio delivery, wherein the audio delivery includes one or a combination of: an audio message, music, and sounds.
